(19) United States
(12) Patent Application Publication
(10) Pub. No.: US 2010/0047040 A1
(43) Pub. Date: Feb. 25, 2010

(54) DEPLOYMENT SYSTEM

(75) Inventors: Trevor Michael Burgess, Aberdeen (GB); Mauro Zaccaria, Aberdeen (GB)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: EXPRO NORTH SEA LIMITED, Aberdeen (GB)

(21) Appl. No.: 12/301,721

(22) PCT Filed: May 21, 2007
(86) PCT No.: PCT/GB2007/001860

§ 371 Date: Sep. 22, 2009

(30) Foreign Application Priority Data
May 24, 2006 (GB) 0610268.5

(51) Int. Cl. B63B 27/00; B63B 35/00; B65G 67/60

(52) U.S. Cl. 414/137.7

(57) ABSTRACT

A deployment system (12) for deploying equipment from a vessel (10), such as sea going vessel, comprises a support structure (18) adapted to be mounted on the deck (14) of a vessel (10) and a cradle (20) mounted on the support structure (18) and adapted to be support equipment (16) to be deployed, wherein the cradle (20) is configurable between storage configuration and a deployment configuration. A carriage (22) is mounted on the cradle (20) and is adapted to engage equipment (16) to be deployed, wherein the carriage (22) is translatable relative to the cradle (20) to move equipment (16) between stored and deployed positions. In one disclosed embodiment, the deployment system (12) is arrangement for use in deploying an elongate structure, such as a subsea well intervention system, for a sea going vessel (10).

### FIELD OF THE INVENTION

The present invention relates to a deployment system, and in particular to a system for use in deploying and retrieving equipment from and to an offshore vessel.

### BACKGROUND TO THE INVENTION

In the oil and gas industry there is a requirement to deploy and retrieve equipment and components into and from the sea from floating vessels, such as supply boats and anchor handling vessels. Subsea equipment may include Christmas trees for coupling to a subsea wellhead, BOP stacks, intervention systems, subsea processing equipment including pumps, separators, injectors, meters, valves, chokes, manifolds and the like. In many cases the subsea equipment is very heavy, typically from a few tons up to around 200 tons, and very long, for example between 5 to 40 metres in length. This makes handling such equipment very difficult. For example, where very long components are to be deployed and installed vertically, these must be transported in a horizontal position, and subsequently moved to a vertical orientation upon deployment. The reverse is true when the equipment is to be retrieved. This therefore requires specialised handling equipment to be provided in order to properly and safely deploy the subsea equipment.

In many cases vessels are fitted with large handling cranes. However, these often have a significant footprint, using valuable deck space. Alternatively, a dedicated lifting vessel may be required to lift the subsea equipment to and/or from a suitable transport vessel. Where lifting cranes are utilised, significant human interaction may be required, for example to couple lifting components, monitor movement of the equipment and relay commands to a crane operator or the like. Accordingly, personnel may be required to operate in a hazardous environment.

When deploying equipment from a floating vessel, it is difficult to retain proper control through the splash zone. Additionally, conventional lifting and handling equipment may not adequately accommodate for the movement of the vessel as a result of waves and wind. As such, proper control of the equipment may be difficult, particularly when attempting to land the equipment on the seabed or on subsea apparatus to prevent causing damage to the equipment or subsea apparatus.

### SUMMARY OF THE INVENTION

According to a first aspect of the present invention, there is provided a deployment system for deploying equipment from a vessel, said system comprising:
a support structure adapted to be mounted on the deck of a vessel;
a cradle mounted on the support structure and adapted to support equipment to be deployed, said cradle being configurable between a storage configuration and a deployment configuration; and
a carriage mounted on the cradle and adapted to engage equipment to be deployed, said carriage being translatable relative to the cradle to move equipment between stored and deployed positions.

The carriage may be translatable relative to the cradle in any plane.

Preferably, the system is adapted to retrieve equipment to a vessel upon which the system is mounted.

The cradle is adapted to be translated relative to the support structure between retracted and extended positions. Preferably, when in the retracted position all or at least a major portion of the cradle is located over the deck of the vessel. Preferably also, when in the extended position at least a portion of the cradle extends beyond the edge of the deck of the vessel.

Preferably, at least a portion of the cradle is adapted to be pivoted relative to the support structure towards a tilted position. More preferably, at least a portion of the cradle is adapted to be pivoted relative to the support structure when said cradle is located in its extended position. Advantageously, the cradle is reconfigured into the deployment configuration by a combination of being translated towards the extended position and then pivoted towards the tilted position.

In use, the cradle may be translated to the extended position and then pivoted to tilt a portion of the cradle over the edge of the deck of the vessel and preferably into the sea. Once the cradle is positioned within this deployment configuration the equipment to be deployed may be moved by the carriage from the stored position to the deployed position. Tilting a portion of the cradle into the sea provides a fixed transition through the splash zone of the sea, permitting controlled deployment of equipment by the carriage through this hazardous zone.

In one embodiment the cradle comprises a frame mounted on a translatable support, wherein the translatable support is mounted on the support structure. Preferably, the carriage of the deployment system is mounted on the frame of the cradle and is translatable relative thereto. Preferably also, in use, the frame is adapted to contain at least a portion of equipment to be deployed.

The translatable support may be slidably mounted on the support structure. Alternatively, and in a preferred embodiment, the translatable support is mounted on the support structure via friction reducing means. The friction reducing means may comprise at least one and preferably a plurality of rolling bodies, which may be freely positioned between the translatable support and support structure, or alternatively may be fixed to at least one of the supports, or any suitable combination thereof. The rolling bodies may comprise rollers, wheels, balls or the like.

The support structure may comprise at least one and preferably a plurality of rails upon which the translatable support is mounted. The translatable support may comprise a dolly or cart, for example.

Advantageously, the translatable support may be coupled to the support structure in a manner to prevent inadvertent separation thereof. For example, the support structure may comprise one or more channels within which at least a portion of the translatable support is adapted to be received and moved. Alternatively, or additionally, the translatable support may comprise a plurality of rolling members rotatably coupled thereto, wherein said rolling members are adapted to be received within the channels of the support structure.

In a preferred embodiment the frame of the cradle is pivotally mounted on the translatable support, preferably in the region of one end of the translatable support.

Preferably, the system comprises drive means adapted to translate the cradle relative to the support structure. In one embodiment the drive means comprises hydraulic drive means such as a piston or ram arrangement. A single stage piston arrangement may be provided, or alternatively a multiple stage piston arrangement may be provided which advantageously permits a greater degree of translation to be achieved. This is beneficial where long equipment is to be transported and deployed. Alternatively, or additionally, a gearing arrangement may be utilised, such as a rack and pinion gear arrangement adapted to be driven by a motor, such as an electric motor.

The drive means may be mounted between the deck of the vessel and the translatable support, or alternatively between the support structure and the translatable support. Alternatively further, the drive means may be mounted directly on the translatable support. In this arrangement the drive means may comprise a motor adapted to drive the translatable support, for example via a friction or geared connection with one or both of the support structure and deck of the vessel.

Preferably, the system further comprises drive means adapted to pivot the frame of the cradle relative to the support structure and the translatable support. In one embodiment the pivot drive means comprises hydraulic drive means, such as a hydraulic piston arrangement or the like. Alternatively, the pivot drive means may comprise an electric motor or the like adapted to drive a gearing arrangement, for example. Alternatively further, the pivot drive means may comprise a winch arrangement. The pivot drive means may be provided between the frame and the translatable support. Alternatively, the pivot drive means may be provided between the frame of the cradle and the support structure, or alternatively the deck of the vessel.

The carriage may be slidably mounted on the cradle. Alternatively, the carriage may be mounted on the cradle via friction reducing means such as at least one and preferably a plurality of rolling bodies, such as rollers, wheels, balls or the like. At least a portion of the carriage may be received within one or more channels formed in or on the cradle to prevent inadvertent separation of the carriage and cradle.

In one embodiment the carriage may be translated by hydraulic drive means, such as by a piston arrangement or the like. Alternatively, the carriage may be translated by a motor driving a gear arrangement or the like. Alternatively further, the carriage may be translated by a cable or chain drive system or the like.

Preferably, the carriage is adapted to engage and couple to equipment to be deployed by a latching arrangement, such as a male-to-female engaging and latching arrangement. Preferably, the system further comprises an adaptor to be secured to the equipment and to be engaged and coupled to the carriage. The adaptor may form part of a protective structure adapted to surround the equipment to be deployed.

Preferably, the system comprises a winch arrangement adapted to be secured to the equipment and to deploy the equipment to the required depth within the sea once released from the carriage. The winch arrangement preferably comprises a winch drum and a reelable medium, such as steel rope, chain, wireline or the like. The winch drum may be mounted on the support structure, or may alternatively be mounted on the cradle, on the deck or other portion of the vessel. Preferably, the winch arrangement comprises means for securing the reelable medium to the equipment to be deployed.

In a preferred embodiment the carriage comprises a guide adapted to engage and direct the reelable medium in the required direction. The guide may comprise a gooseneck arrangement mounted on the carriage, preferably the upper end of the carriage when in use.

The cradle may define a slot adapted to accommodate the reelable medium when the carriage is translated along the cradle.

Preferably, the system comprises a compensator system adapted to compensate for heave of the vessel. Preferably, the compensator system is adapted to minimise undulation movement of the equipment when being moved through the sea as a result of heave of the vessel upon which the system is mounted. This arrangement advantageously minimises impulse loading on the reelable medium and permits the equipment to be accurately and carefully landed at the target destination, such as a Christmas tree, thus preventing damage to the equipment or target destination. In a preferred embodiment, the compensator system is coupled to the winch arrangement, and more preferably coupled between the equipment to be deployed/retrieved and the reelable medium of the winch arrangement. The compensator system may therefore provide means for securing the reelable medium to the equipment. Advantageously, the compensator system is secured to a protective structure surrounding the equipment. The compensator system may surround a portion of the equipment and adapted to provide protection to said portion of the equipment.

Preferably, the compensator system comprises first and second portions, the first portion being adapted to be secured to the equipment and the second portion being adapted to be secured to the reelable medium, wherein the first and second portions are coupled together via a piston arrangement. The piston arrangement is preferably adapted to adjust the separation of the first and second portions to accommodate for heave of the vessel. The compensator system may be activated/de-activated by hydrostatic pressure and adjustment may be initiated and achieved by monitoring and accommodating changes in hydraulic load.

Preferably, the system comprises alignment means adapted to align equipment to be retrieved with the carriage to permit the equipment to become correctly secured to the carriage. In a preferred embodiment the alignment means comprises a profile on one of the carriage and equipment and a slot in the other of the carriage and equipment, wherein, in use, the profile is guided and aligned to be received within the slot. The alignment means may comprise a mule shoe arrangement. One of the carriage and equipment may comprise a cage defining a cam surface and a slot, wherein a profile on the other of the carriage and equipment is adapted to engage the cam surface to cause rotation of the equipment when the carriage and equipment are brought together, such that the profile may be received within the slot. The compensator system may form part of the alignment means.

The system of the present invention may be adapted to be mounted on a seagoing vessel, such as a ship or floating platform or the like. Alternatively, in aspects of the invention the system may be adapted to be mounted onshore, adjacent a body of water, such as on a pier, harbour or the like.

Preferably, the system of the present invention may be adapted for use in deploying/retrieving a rigless intervention system to be mounted on a Christmas tree. Such a rigless intervention system is disclosed in applicant's international patent publication no. WO 2004/065757.

According to a second aspect of the present invention, there is provided a vessel comprising a deployment system for deploying equipment from the vessel, said system comprising:
a support structure adapted to be mounted on the deck of a vessel;
a cradle mounted on the support structure and adapted to support equipment to be deployed, said cradle being configurable between a storage configuration and a deployment configuration; and
a carriage mounted on the cradle and adapted to engage equipment to be deployed, said carriage being translatable relative to the cradle to move equipment between stored and deployed positions.

The vessel may be a seagoing vessel, such as a ship or floating platform or the like.

### BRIEF DESCRIPTION OF THE DRAWINGS

These and other aspects of the present invention will now be described, by way of example only, with reference to the accompanying drawings, in which:

FIG. 1 is a perspective view of a vessel incorporating a deployment system in accordance with an embodiment of the present invention;

FIG. 2 is an enlarged view of the deployment system of FIG. 1;

FIG. 3 is a view of the vessel of FIG. 1 from the rear with a portion of the deployment system submerged in water;

FIG. 4 is an enlarged view of a cradle portion of the deployment system of FIG. 1;

FIG. 5 is an enlarged perspective view of a carriage portion of the deployment system of FIG. 1;

FIG. 6 is an enlarged perspective view of equipment to be deployed and retrieved by the deployment system of FIG. 1;

FIGS. 7 and 8 are diagrammatic representations of the cradle, carriage and equipment in use;

FIG. 9 is a diagrammatic view of a compensator system of the deployment system of FIG. 1;

FIG. 10 is an enlarged diagrammatic view of an alignment cage of the deployment system of FIG. 1; and

FIG. 11 is an enlarged view of a portion of the deployment system of FIG. 1, with the equipment shown dismantled.

### DETAILED DESCRIPTION OF THE DRAWINGS

Reference is first made to FIG. 1 of the drawings in which there is shown a vessel 10 comprising a deployment system 12 in accordance with an embodiment of aspects of the present invention. The deployment system 12 is mounted on the deck 14 of the vessel 10 and, as will be described in further detail below, is for deploying and retrieving equipment 16 from and to the vessel 10. Typically, the system 12 is for deploying and retrieving equipment 16 which may weigh in excess of 150 tons and be around 40 metres in length, which makes handling of the equipment by conventional methods very difficult. Also, the system 12 is particularly beneficial for deploying and retrieving such large equipment which must be stored in a horizontal position yet must be installed at the desired location in a vertical position. Although many forms and types of equipment may be deployed/retrieved utilising the system 12 of the present invention, the equipment 16 in the exemplary embodiment shown in the drawings comprises a rigless intervention system which is to be installed on top of a subsea Christmas tree. Such a rigless intervention system is disclosed in applicant's international patent publication no. WO 2004/065757.

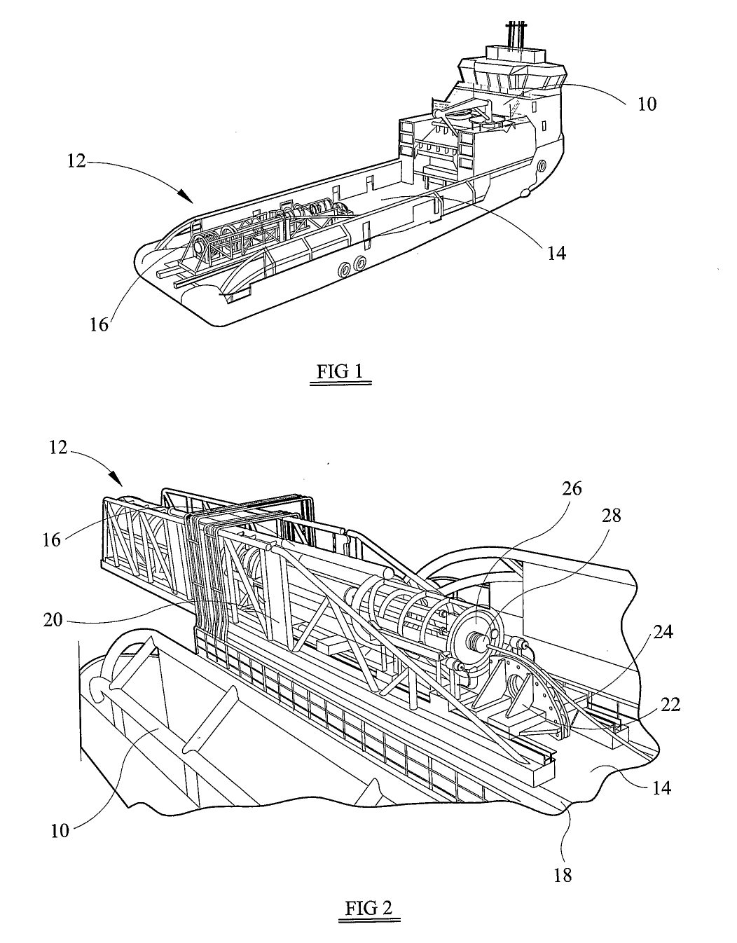

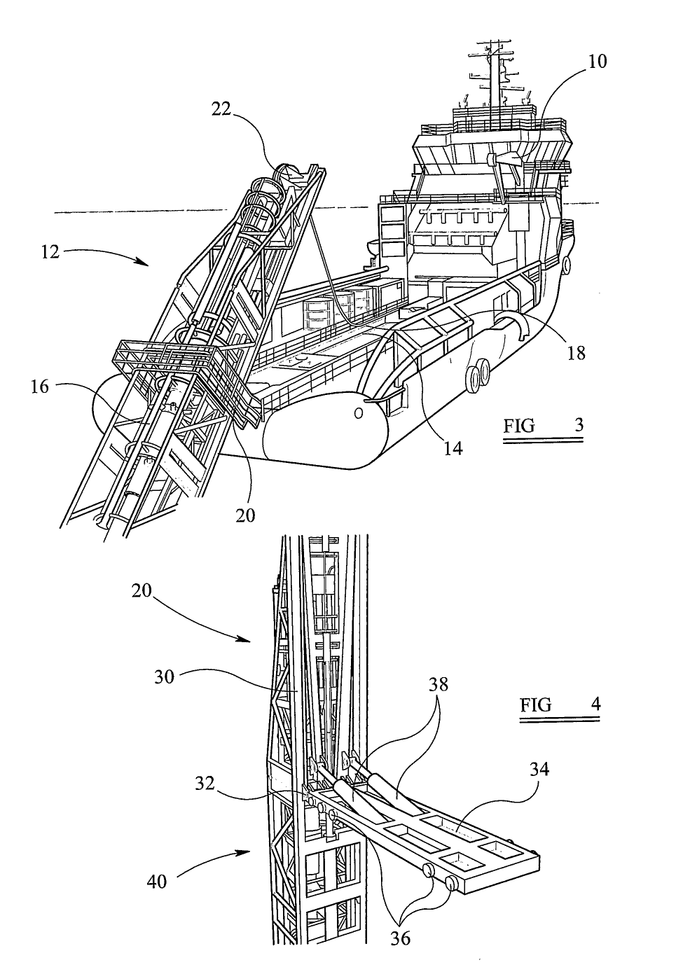

An enlarged view of the system 12 is shown in FIG. 2, reference to which is now made. The system comprises a support structure in the form of a pair of rails 18 which are mounted and secured to the deck 14 of the vessel 10. A cradle 20 is mounted on the rails 18 and is capable of being translated along the rails 18 between a retracted position, as shown in FIG. 1, and an extended position, as shown in FIG. 2. When in the retracted position the entire cradle 20 is positioned over the deck 14, whereas in the extended position a portion of the cradle 20 extends beyond the rear edge of the deck 14. The cradle 20 supports the equipment 16 to be deployed. The cradle 20 will be described in further detail below.

A carriage 22 is mounted on the cradle 20 and is adapted to engage the equipment 16, said carriage 22 being translatable relative to the cradle 20 to move the equipment 16 between a stored position, as shown in FIG. 2, and a deployed position, described below. A cable 24 is secured to an upper end 26 of the equipment 16 via a releasable connection 28, wherein the cable is for lowering and raising the equipment through the water when released from the system 12. The cable is paid in and out from a winch drum (not shown) which is mounted on the deck 14 of the vessel 10.

Referring to FIG. 3, which is a view of the vessel 10 from the rear, the cradle 20 is shown being pivoted relative to the support structure 18 to tilt a portion of the cradle 20 and thus equipment 16 over the edge of the deck 14 and into the sea. The cradle 20 may be tilted to any required position, and even beyond a vertical position which advantageously permits the system 12 to be operated in seas experiencing high current flows. Once in the required orientation, the equipment 16 may be lowered further into the sea by downward translation of the carriage 22. Tilting a portion the cradle 20 into the sea provides a fixed transition through the splash zone of the sea, permitting controlled deployment of the equipment 16 by the carriage 22 through this hazardous zone.

A detailed description of the cradle 20 will now be given with reference to FIG. 4. The cradle 20 comprises a frame 30 upon which the carriage 22 and equipment 16 are mounted, wherein the frame 30 is pivotally mounted via a pin connection 32 to a translatable support or cart 34. The cart 34 is mounted on the support structure 18 (FIGS. 2 and 3) via rolling bodies 36 which are rotatably mounted on the cart 34. The frame 30 is caused to pivot relative to the cart 34 by a pair of hydraulic rams 38. In use, the cart 34 may be translated along the support structure 18 (FIGS. 2 and 3), for example via a staged piston arrangement (not shown), until the lower portion 40 of the frame 30 extends beyond the deck of the vessel. The frame 30 may then be pivoted to the required tilt orientation to submerge the lower portion 40 of the frame 30 in the sea.

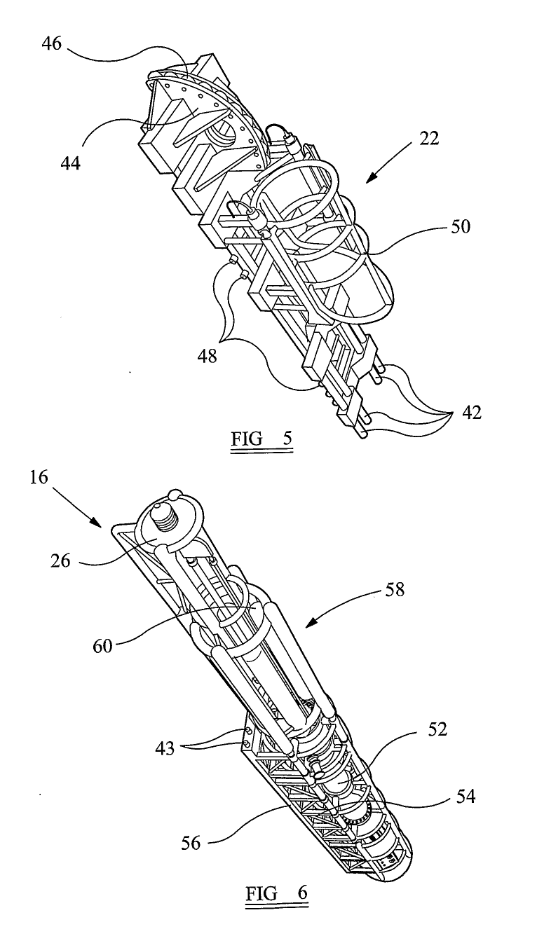

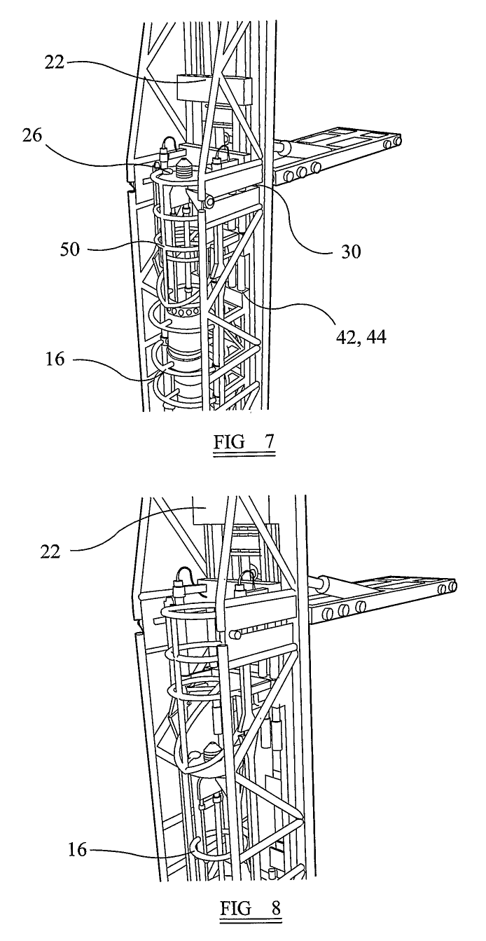

Reference is now made to FIG. 5 in which there is shown a perspective view of the carriage 22 removed from the system 12. The carriage 22 in the embodiment shown comprises four female latching components 42 located on a lower end thereof which are adapted to engage and become releasably secured to corresponding male latching lugs on the equipment. The lugs are identified by reference numeral 43 in FIG. 6. Mounted on an upper end of the carriage 22 is a gooseneck 44 comprising a number of rollers 46 for guiding and supporting the cable (not shown) used to deploy/retrieve the equipment. The carriage 22 is mounted on the frame 30 of the cradle (not shown) via a number of rollers 48. An alignment cage 50 is secured to the carriage 22, within which cage 50 an upper portion of the tool is inserted. In use, the alignment cage 50 ensures that the equipment is properly aligned upon initial engagement and pick-up by the carriage 22 when the equipment is being retrieved. The operation of the alignment cage 50 will be described in detail below.

A perspective view of the equipment 16, removed from the system 12, is shown in FIG. 6, reference to which is now made. The equipment 16 is of a modular construction and once assembled comprises a central tool portion, which in the embodiment shown is a rigless intervention system 52, surrounded and mounted on a protective cage 54. The protective cage 54 incorporates a skid arrangement 56 which is adapted to slide along the frame (not shown) when the equipment 16 is being deployed and retrieved. The latching lugs 43 are mounted on an upper end of the protective cage 54. Mounted on the equipment 16 is a compensator system 58 which in use accommodates for heave of the vessel during deployment/retrieval of the equipment 16. As shown, the compensator system is mounted on an upper end of the protective cage 54 and in the embodiment shown surrounds and protects a portion of a wireline lubricator 60. The compensator system will be described in further detail below. The upper portion 26 of the equipment is adapted to be inserted within the alignment cage 50 (FIG. 5) of the carriage 22.

The carriage 22 and equipment 16 are shown secured together and located on the frame 30 in FIG. 7, reference to which is now made. It should be noted that the gooseneck 44 (FIG. 5) and cable 24 (FIG. 2) are not shown in FIG. 7 for the purposes of clarity. As shown, the upper end 26 of the equipment 16 is inserted within the alignment cage 50 and the latching components 42, 44 are secured together. The carriage 22 is shown in FIG. 7 in a lower or deployed position. Once the carriage 22 is in this deployment position the latching components 42, 44 may be released and the equipment 16 lowered, as shown in FIG. 8, by the cable, which is not shown in FIG. 8.

The compensator system 58 will now be described in detail with reference to FIG. 9. The compensator system comprises a number of cylinders 62 which are secured to the upper portion 26 (FIG. 6) of the equipment 16, and a corresponding number of pistons 64 secured to the protective cage 54 and engaged within respective cylinders 62. In use, the cylinders and pistons 62, 64 vary the separation of the upper portion of the equipment, which in use is secured to the deployment/retrieval cable, and the protective cage 54 to accommodate for heave of the vessel. The compensator system 58 is activated/de-activated by hydrostatic pressure and adjustment is initiated and achieved by monitoring and accommodating changes in hydraulic load. Accordingly, in use, the compensator system 58 minimises undulation movement of the equipment 16 when being moved through the sea which minimises impulse loading on the reelable medium, and also permits the equipment 16 to be accurately and carefully landed at the target destination.

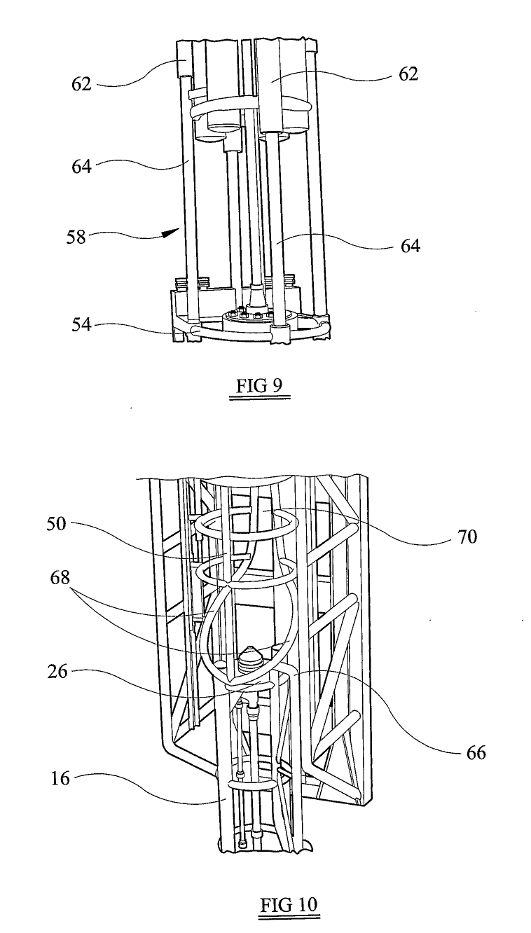

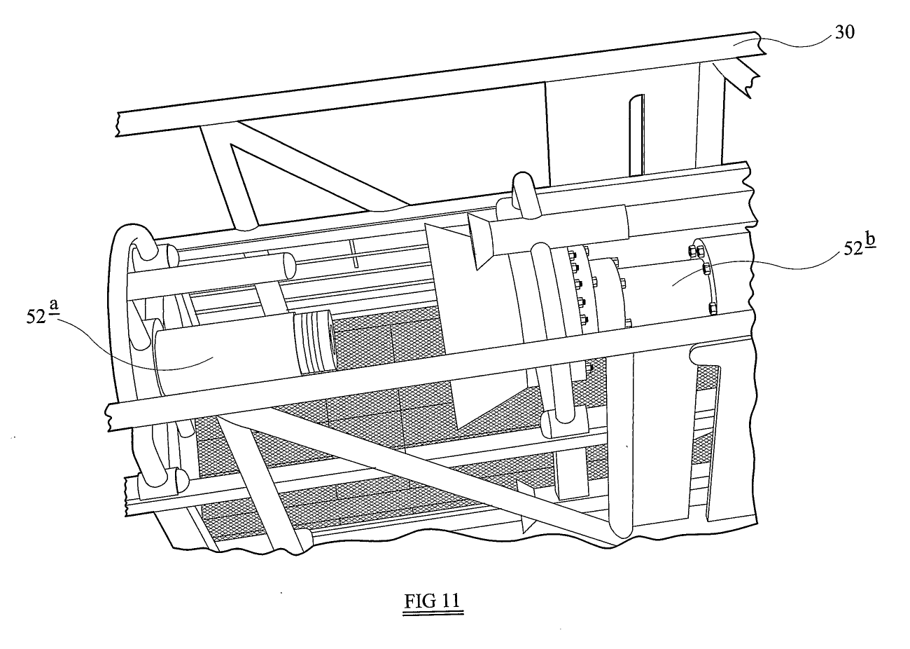

Reference is now made to FIG. 10 in which there is shown an enlarged perspective view of the alignment cage 50 of the carriage 22 in use engaging and aligning the equipment 16. The alignment cage 50 is generally in the form of a mule shoe. Once the equipment 16 has been retrieved by the cable (not shown for clarity) to the position shown, the carriage 22 is then translated downwards over the upper portion 26 of the equipment, which upper portion 26 comprises a protruding structure 66. If the equipment 16 is incorrectly aligned for pick-up by the carriage 22, then the protruding structure 66 is engaged by a curved edge 68 of the downwardly moving alignment cage 50 which causes the equipment 16 to be rotated and the protruding structure 66 guided into a slot 70 defined in the rear of the alignment cage 50. Once the protruding structure 66 is located within slot 70 then the latching components are properly aligned for engagement.

As noted above, the equipment 16 is of a modular construction. Advantageously, the frame 30 of the cradle 20 permits the equipment 16 to be separated when supported thereon, as shown in FIG. 11. Accordingly, the tool may be separated into separate components 52a, 52b for maintenance, inspection or the like without having to be brought to shore.

It should be understood that the embodiment described is merely exemplary of the present invention at that modifications may be made thereto without departing from the scope of the invention. For example, the deployment system may be utilised to deploy/retrieve any subsea equipment. Additionally, the system may be secured onshore adjacent a body of water, and as such is not entirely limited for use offshore.

1. A deployment system for deploying equipment from a vessel, said system comprising:
a support structure adapted to be mounted on the deck of a vessel;
a cradle mounted on the support structure and adapted to support equipment to be deployed, said cradle being configurable between a storage configuration and a deployment configuration; and
a carriage mounted on the cradle and adapted to engage equipment to be deployed, said carriage being translatable relative to the cradle to move equipment between stored and deployed positions.

2. The system of claim 1, wherein the carriage is translatable relative to the cradle in any plane.

3. The system of claim 1, wherein the system is adapted to retrieve equipment to a vessel upon which the system is mounted.

4. The system of claim 1, wherein the cradle is adapted to be translated relative to the support structure between retracted and extended positions.

5. The system of claim 1, wherein, when in the retracted position, at least a major portion of the cradle is located over the deck of the vessel.

6. The system of claim 1, wherein, when in the extended position, at least a portion of the cradle extends beyond the edge of the deck of the vessel.

7. The system of claim 1, wherein at least a portion of the cradle is adapted to be pivoted relative to the support structure towards a tilted position.

8. The system of claim 1, wherein the cradle is reconfigured into the deployment configuration by a combination of being translated towards the extended position and then pivoted towards the tilted position.

9. The system of claim 1, wherein the cradle comprises a frame mounted on a translatable support, wherein the translatable support is mounted on the support structure.

10. The system of claim 9, wherein the carriage of the deployment system is mounted on the frame of the cradle and is translatable relative thereto.

11. The system of claim 9, wherein the frame is adapted to contain at least a portion of equipment to be deployed.

12. The system of claim 9, wherein the translatable support is slidably mounted on the support structure.

13. The system of claim 9, wherein the translatable support is mounted on the support structure via friction reducing means.

14. The system of claim 9, wherein the frame of the cradle is pivotally mounted on the translatable support.

15. The system of claim 1, further comprising drive means adapted to translate the cradle relative to the support structure.

16. The system of claim 15, wherein the drive means comprises hydraulic drive means such as a piston or ram arrangement.

17. The system of claim 16, wherein the hydraulic drive means comprises at least one piston.

18. The system of claim 15, wherein the drive means comprises mechanical drive means

19. The system of claim 15, wherein the drive means is mounted between the support structure and the translatable support.

20. The system of claim 1, further comprising drive means adapted to pivot the frame of the cradle relative to the support structure.

21. The system of claim 20, wherein the pivot drive means comprises hydraulic drive means.

22. The system of claim 20, wherein the pivot drive means comprises mechanical drive means.

23. The system of claim 20, wherein the pivot drive means is provided between the frame and the translatable support.

24. The system of claim 1, wherein the carriage is slidably mounted on the cradle.

25. The system of claim 1, wherein the carriage is mounted on the cradle via friction reducing means.

26. The system of claim 1, wherein the carriage is translated by hydraulic drive means.

27. The system of claim 1, wherein the carriage is translated by mechanical drive means.

28. The system of claim 1, wherein the carriage is adapted to engage and couple to equipment to be deployed by a latching arrangement.

29. The system of claim 1, further comprising an adaptor to be secured to equipment to be deployed and to be engaged and coupled to the carriage.

30. The system of claim 29, wherein the adaptor forms part of a protective structure adapted to surround the equipment to be deployed.

31. The system of claim 1, further comprising a winch arrangement adapted to be secured to and. deploy equipment.

32. The system of claim 31, wherein the winch arrangement comprises a winch drum and a reelable medium.

33. The system of claim 32, wherein the carriage comprises a guide adapted to engage and direct the reelable medium in the required direction.

34. The system of claim 32, wherein the cradle defines a slot adapted to accommodate the reelable medium when the carriage is translated along the cradle.

35. The system of claim 1, further comprising a compensator system adapted to compensate for heave of the vessel.

36. The system of claim 35, wherein the compensator system is coupled between equipment to be deployed/retrieved and the winch arrangement.

37. The system of claim 35, wherein the compensator system is secured to a protective structure surrounding the equipment.

38. The system of claim 35, wherein the compensator system comprises first and second portions, the first portion being adapted to be secured to the equipment and the second portion being adapted to be secured to the winch arrangement, wherein the first and second portions are coupled together via a piston arrangement.

39. The system of claim 38, wherein the piston arrangement is adapted to adjust the separation of the first and second portions to accommodate for heave of the vessel.

40. The system of claim 1, further comprising alignment means adapted to align equipment to be retrieved with the carriage to permit the equipment to become correctly secured to the carriage.

41. The system of claim 40, wherein the alignment means comprises a profile on one of the carriage and equipment and a slot in the other of the carriage and equipment, wherein, in use, the profile is guided and aligned to be received within the slot.

42. The system of claim 40, wherein one of the carriage and equipment may comprise a cage defining a cam surface and a slot, wherein a profile on the other of the carriage and equipment is adapted to engage the cam surface to cause rotation of the equipment when the carriage and equipment are brought together, such that the profile may be received within the slot.

43. A vessel comprising a deployment system for deploying equipment from the vessel, said system comprising:
a support structure adapted to be mounted on the deck of a vessel;
a cradle mounted on the support structure and adapted to support equipment to be deployed, said cradle being configurable between a storage configuration and a deployment configuration; and
a carriage mounted on the cradle and adapted to engage equipment to be deployed, said carriage being translatable relative to the cradle to move equipment between stored and deployed positions.
